(19) United States
(12) Patent Application Publication
(10) Pub. No.: US 2020/0075210 A1
(43) Pub. Date: Mar. 5, 2020

(54) Magnetic Adsorption Device

(71) Applicants: Tyco Electronics (Shanghai) Co. Ltd., Shanghai (CN); TE Connectivity Corporation, Berwyn, PA (US)

(72) Inventors: Chun Wei Huang, Shanghai (CN); Zongjie Tao, Shanghai (CN); Lvhai Hu, Shanghai (CN); Dandan Zhang, Shanghai (CN); Roberto Francisco-Yi Lu, Bellevue, WA (US)

(73) Assignees: Tyco Electronics (Shanghai) Co. Ltd., Shanghai (CN); TE Connectivity Corporation, Berwyn, PA (US)

(21) Appl. No.: 16/554,808

(22) Filed: Aug. 29, 2019

(30) Foreign Application Priority Data
Aug. 29, 2018 (CN) 201810994874.1

(51) Int. Cl. H01F 7/02; H01F 7/04; B25J 15/06; B23Q 3/154

(52) U.S. Cl. CPC H01F 7/0257; H01F 7/04; H02K 11/21; B23Q 3/154; B25J 15/06

(57) ABSTRACT

A magnetic adsorption device includes an electromagnet, a pickup member made of a magnetizable material and disposed in a magnetic field of the electromagnet, and a magnetic shield sleeve sleeved on the pickup member and movable back and forth with respect to the pickup member. The pickup member is adapted to adsorb an electronic device by a magnetic force. A length of a portion of the pickup member exposed from the magnetic shield sleeve is adjustable by moving the magnetic shield sleeve to adjust the magnetic force of the pickup member.

### CROSS-REFERENCE TO RELATED APPLICATION

This application claims the benefit of the filing date under 35 U.S.C. § 119(a)-(d) of Chinese Patent Application No. 201810994874.1, filed on Aug. 29, 2018.

### FIELD OF THE INVENTION

The present invention relates to a magnetic adsorption device and, more particularly, to a magnetic adsorption device adapted to pick up an electronic device.

### BACKGROUND

A vacuum adsorption device is typically employed to pick up an electronic device. The vacuum adsorption device has a vacuum nozzle adapted to be suctioned or adsorbed onto a flat surface of the electronic device. However, some electronic devices, for example, tiny electronic devices smaller in size than the vacuum nozzle, highly complicated electronic devices, and electronic devices without flat surfaces, and the like, cannot be adsorbed by the vacuum nozzle. Currently, these electronic devices can only be picked up manually or by a robot. However, such electronic devices are required to be clamped, which may easily damage the electronic devices and result in a very low pickup efficiency.

### SUMMARY

A magnetic adsorption device includes an electromagnet, a pickup member made of a magnetizable material and disposed in a magnetic field of the electromagnet, and a magnetic shield sleeve sleeved on the pickup member and movable back and forth with respect to the pickup member. The pickup member is adapted to adsorb an electronic device by a magnetic force. A length of a portion of the pickup member exposed from the magnetic shield sleeve is adjustable by moving the magnetic shield sleeve to adjust the magnetic force of the pickup member.

### BRIEF DESCRIPTION OF THE DRAWINGS

The invention will now be described by way of example with reference to the accompanying Figures, of which:

FIG. 1 is a perspective view of a magnetic adsorption device according to an embodiment in which a portion of a pickup member is exposed from a magnetic shield sleeve;

FIG. 2 is a perspective view of the magnetic adsorption device in which the portion of the pickup member exposed from the magnetic shield sleeve is greater than in FIG. 1;

FIG. 3 is a perspective view of the magnetic adsorption device in which the portion of the pickup member exposed from the magnetic shield sleeve is greater than in FIG. 2; and

FIG. 4 is a perspective view of the magnetic adsorption device in which the portion of the pickup member exposed from the magnetic shield sleeve is greater than in FIG. 3.

### DETAILED DESCRIPTION OF THE EMBODIMENT(S)

The technical solution of the disclosure will be described hereinafter in further detail with reference to the following embodiments, taken in conjunction with the accompanying drawings. In the specification, the same or similar reference numerals indicate the same or similar parts. The description of the embodiments of the disclosure hereinafter with reference to the accompanying drawings is intended to explain the general inventive concept of the disclosure and should not be construed as a limitation on the disclosure.

In addition, in the following detailed description, for the sake of explanation, numerous specific details are set forth in order to provide a thorough understanding of the disclosed embodiments. It will be apparent, however, that one or more embodiments may also be practiced without these specific details. In other instances, well-known structures and devices are illustrated schematically in order to simplify the drawing.

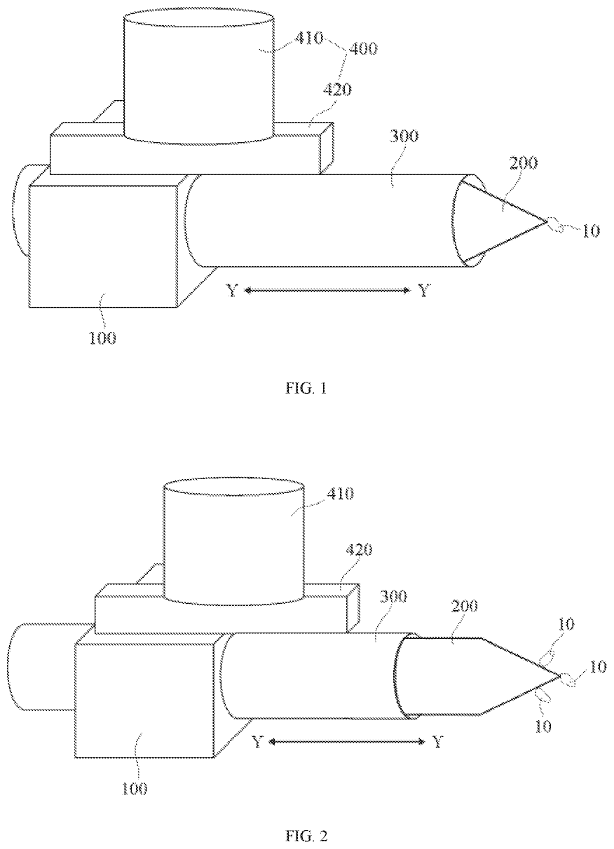

A magnetic adsorption device according to an embodiment, as shown in FIG. 1, comprises an electromagnet 100, a pickup member 200, and a magnetic shield sleeve 300. The pickup member 200 is made of a magnetizable material and is disposed in a magnetic field of the electromagnet 100. The pickup member 200 generates a magnetic force under the magnetic field of the electromagnet 100 so as to adsorb an electronic device 10 by the magnetic force. The magnetic shield sleeve 300 has a front end close to a tip of the pickup member 200. The magnetic force of the pickup member 200 is controlled by controlling a distance between the front end of the magnetic shield sleeve 300 and the tip of the pickup member 200.

In the embodiment shown in FIG. 1, the pickup member 200 is a needle-like member. In an embodiment, the pickup member 200 is made of a magnetizable metal or alloy material thereof. In another embodiment, the magnetizable material from which the pickup member 200 is made may include at least one of cast steel, silicon steel, carbon steel, iron, cobalt, nickel, and alloy oxide thereof.

As shown in FIGS. 1-4, the magnetic shield sleeve 300 is sleeved over the pickup member 200 and is movable back and forth with respect to the pickup member 200 in an axial direction Y. Therefore, it is possible to adjust a length of a portion of the pickup member 200 exposed from the magnetic shield sleeve 300 and a magnetic force of the pickup member 200 for adsorbing the electronic device 10 by moving the magnetic shield sleeve 300.

The length of the portion of the pickup member 200 shown in FIG. 1 exposed from the magnetic shield sleeve 300 is the shortest, and thus the pickup member 200 shown in FIG. 1 has the smallest magnetic force. Therefore, the number of electronic devices 10 adsorbed by the pickup member 200 shown in FIG. 1 is the smallest. The pickup member 200 shown in FIG. 1 may adsorb, for example, only one electronic device 10.

The portion of the pickup member 200 shown in FIG. 2 exposed from the magnetic shield sleeve 300 has a length longer than that of the portion of the pickup member 200 shown in FIG. 1, and the pickup member 200 shown in FIG. 2 has a magnetic force greater than that of the pickup member 200 shown in FIG. 1. Therefore, the number of the electronic devices 10 adsorbed by the pickup member 200 shown in FIG. 2 is greater than the number of the electronic devices 10 adsorbed by the pickup member 200 shown in FIG. 1. The pickup member 200 shown in FIG. 2 may adsorb, for example, three electronic devices 10.

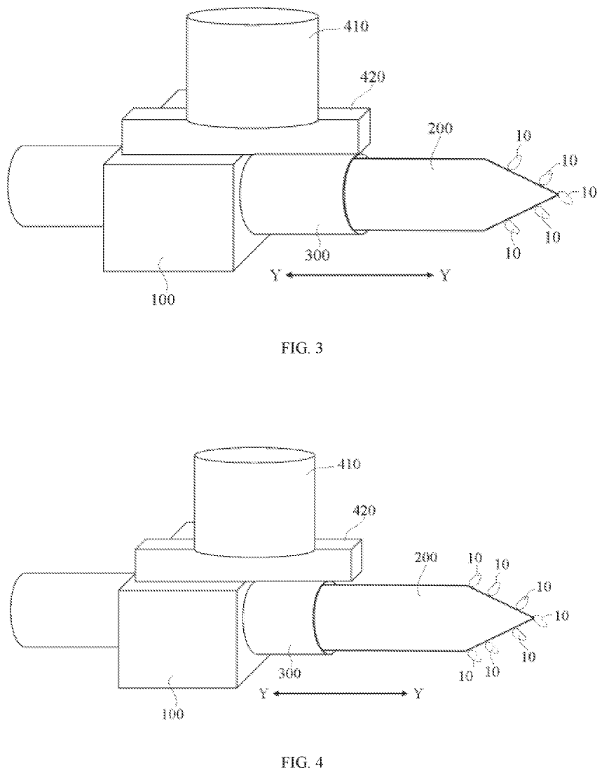

The portion of the pickup member 200 shown in FIG. 3 exposed from the magnetic shield sleeve 300 has a length longer than that of the portion of the pickup member 200 shown in FIG. 2 exposed from the magnetic shield sleeve 300, and thus the pickup member 200 shown in FIG. 3 has a magnetic force greater than that of the pickup member 200 shown in FIG. 2. Therefore, the number of the electronic devices 10 that may be attracted by the pickup member 200 shown in FIG. 3 is greater than the number of electronic devices 10 adsorbed by the pickup member 200 shown in FIG. 2. The pickup member 200 shown in FIG. 3 may adsorb, for example, five electronic devices 10.

The portion of the pickup member 200 shown in FIG. 4 exposed from the magnetic shield sleeve 300 has a length longer than that of the portion of the pickup member 200 shown in FIG. 3 exposed from the magnetic shield sleeve 300, and thus the pickup member 200 shown in FIG. 4 has a magnetic force greater than that of the pickup member 200 shown in FIG. 3. Therefore, the number of electronic devices 10 adsorbed by the pickup member 200 shown in FIG. 4 is greater than the number of electronic devices 10 adsorbed by the pickup member 200 shown in FIG. 3. The pickup member 200 shown in FIG. 4 may adsorb, for example, seven electronic devices 10.

The magnetic adsorption device, as shown in FIGS. 1-4, further comprises a drive mechanism 400 adapted to drive the magnetic shield sleeve 300 to move back and forth in the axial direction Y.

In an embodiment, the magnetic adsorption device further comprises a control device adapted to control the drive mechanism 400 so as to control a moving distance of the magnetic shield sleeve 300 with respect to the pickup member 200. The control device is capable of adjusting the length of the portion of the pickup member 200 exposed from the magnetic shield sleeve 300 and the magnetic force of the pickup member 200 for adsorbing the electronic device 10 by controlling the moving distance of the magnetic shield sleeve 300 with respect to the pickup member 200. The number of the electronic devices 10 adsorbed onto the tip of the pickup member 200 may be controlled by controlling the magnetic force of the pickup member 200.

The drive mechanism 400, as shown in FIGS. 1-4, includes a servo motor 410 and a transmission mechanism 420 adapted to convert a rotational motion of the servo motor 410 into a linear motion of the magnetic shield sleeve 300. The control device may control the moving distance of the magnetic shield sleeve 300 with respect to the pickup member 200 by controlling the servo motor 410.

In the embodiment shown in FIGS. 1-4, the pickup member 200 has a tip in a shape of a needle point onto which the electronic device 10 is adsorbed. In other embodiments, the electronic device 10 may also be adsorbed to other portions of the pickup member 200.

In an embodiment, as the front end of the magnetic shield sleeve 300 moves toward the tip of the pickup member 200, the magnetic force of the pickup member 200 gradually disappears or becomes too small to adsorb a single electronic device 10. In this way, the electronic device 10 previously adsorbed onto the tip of the pickup member 200 may automatically fall down from the pickup member 200 due to the gravity so as to put down the picked-up electronic device 10.

In the embodiment shown in FIGS. 1-4, the magnetic shield sleeve 300 has a length greater than that of the pickup member 200, so that the pickup member 200 is adapted to be completely received within the magnetic shield sleeve 300. Thus, when not in use, the pickup member 200 may be completely received within the magnetic shield sleeve 300 by moving the magnetic shield sleeve 300.

In the embodiment shown in FIGS. 1-4, the electromagnet 100 has a passageway through which the magnetic shield sleeve 300 passes. The pickup member 200 is disposed in the magnetic shield sleeve 300. In another embodiment, the magnetic shield sleeve 300 may be disposed beside the electromagnet 100, and the pickup member 200 may be disposed in the magnetic shield sleeve 300.

It should be appreciated by those skilled in this art that the above embodiments are intended to be illustrative, and many modifications may be made to the above embodiments by those skilled in this art, and various structures described in various embodiments may be freely combined with each other without conflicting in configuration or principle.

Although the disclosure have been described hereinbefore in detail with reference to the attached drawings, it should be appreciated that the disclosed embodiments in the attached drawings are intended to illustrate embodiments of the disclosure by way of example, and should not be construed as limitation to the disclosure.

Although several exemplary embodiments have been shown and described, it would be appreciated by those skilled in the art that various changes or modifications may be made to these embodiments without departing from the principles and spirit of the disclosure, the scope of which is defined by the claims and their equivalents.

What is claimed is:

1. A magnetic adsorption device, comprising:
an electromagnet;
a pickup member made of a magnetizable material and disposed in a magnetic field of the electromagnet, the pickup member adapted to adsorb an electronic device by a magnetic force; and
a magnetic shield sleeve sleeved on the pickup member and movable back and forth with respect to the pickup member, a length of a portion of the pickup member exposed from the magnetic shield sleeve is adjustable by moving the magnetic shield sleeve to adjust the magnetic force of the pickup member.

2. The magnetic adsorption device of claim 1, wherein the pickup member is a needle-like member.

3. The magnetic adsorption device of claim 1, wherein the magnetizable material is a magnetizable metal or an alloy material thereof.

4. The magnetic adsorption device of claim 1, wherein the magnetizable material is at least one of a cast steel, a silicon steel, a carbon steel, an iron, a cobalt, a nickel, and an alloy oxide thereof.

5. The magnetic adsorption device of claim 1, further comprising a drive mechanism adapted to drive the magnetic shield sleeve to move back and forth in an axial direction.

6. The magnetic adsorption device of claim 5, further comprising a control device adapted to control the drive mechanism to control a moving distance of the magnetic shield sleeve with respect to the pickup member, adjusting the length of the portion of the pickup member exposed from the magnetic shield sleeve.

7. The magnetic adsorption device of claim 5, wherein the drive mechanism has a servo motor and a transmission mechanism adapted to convert a rotational motion of the servo motor into a linear motion of the magnetic shield sleeve.

8. The magnetic adsorption device of claim 5, wherein the pickup member has a tip with a needle point shape onto which the electronic device is adsorbed.

9. The magnetic adsorption device of claim 8, wherein a number of electronic devices adsorbed onto the tip of the pickup member is controlled by controlling the magnetic force of the pickup member.

10. The magnetic adsorption device of claim 9, wherein the magnetic shield sleeve has a front end close to the tip of the pickup member.

11. The magnetic adsorption device of claim 10, wherein the magnetic force of the pickup member is controllable by controlling a distance between the front end of the magnetic shield sleeve and the tip of the pickup member.

12. The magnetic adsorption device of claim 11, wherein, as the front end of the magnetic shield sleeve moves toward the tip of the pickup member, the magnetic force of the pickup member gradually disappears or becomes too small to adsorb the electronic device.

13. The magnetic adsorption device of claim 1, wherein the pickup member is capable of being completely received within the magnetic shield sleeve.

14. The magnetic adsorption device of claim 1, wherein the electromagnet has a passageway through which the magnetic shield sleeve passes.

15. The magnetic adsorption device of claim 14, wherein the pickup member is disposed in the magnetic shield sleeve.

16. The magnetic adsorption device of claim 1, wherein the magnetic shield sleeve is disposed beside the electromagnet.

17. The magnetic adsorption device of claim 16, wherein the pickup member is disposed in the magnetic shield sleeve.
